(19) United States
(12) Patent Application Publication
(10) Pub. No.: US 2017/0133674 A1
(43) Pub. Date: May 11, 2017

(54) Electroactive Materials for Metal-Ion Batteries

(71) Applicant: NEXEON LIMITED, Oxfordshire (GB)

(72) Inventors: Lisa MURPHY, Hertfordshire (GB); Andrew FLOOD, Oxfordshire (GB); Charles MASON, Oxfordshire (GB); Christopher Michael FRIEND, Oxfordshire (GB)

(21) Appl. No.: 15/321,125

(22) PCT Filed: Aug. 18, 2015
(86) PCT No.: PCT/GB2015/052397

§ 371 Date: Dec. 21, 2016

(30) Foreign Application Priority Data
Aug. 18, 2014 (GB) 1414635.1

(51) Int. Cl. H01M 4/38; H01M 4/66; H01M 4/62; H01M 4/134; H01M 4/1395; H01M 4/04; H01M 10/0563; H01M 10/0569; H01M 10/0587; H01M 2/16; H01M 2/02; C22C 21/02; C22C 28/00; B22F 9/16; H01M 10/0525

(52) U.S. Cl. CPC H01M 4/386; H01M 10/0525; H01M 4/661; H01M 4/625; H01M 4/622; H01M 4/382; H01M 4/134; H01M 4/1395; H01M 4/0404; H01M 4/0471; H01M 10/0563; H01M 10/0569; H01M 10/0587; H01M 2/1653; H01M 2/0222; C22C 21/02; C22C 28/00; B22F 9/16; H01M 2220/30; H01M 2220/20; H01M 2300/0034; H01M 2300/004; H01M 2300/002; B22F 2301/052; B22F 2302/45; B22F 2998/10; B22F 2304/10

(57) ABSTRACT

A particulate material is provided consisting of a plurality of porous particles comprising an electroactive material selected from silicon, germanium or a mixture thereof, wherein the porous particles have a D₅₀ particle diameter in the range of greater than 5 to 25 μm, an intra-particle porosity in the range of from 30 to 90%, and a pore diameter distribution having a peak in the range of from 50 to less than 400 nm as determined by mercury porosimetry. Also provided are electrodes and electrode compositions comprising the particulate material, a rechargeable metal-ion battery comprising the particulate material, and a process for the preparation of the particulate material.

This invention relates in general to electroactive materials for use in electrodes for metal-ion batteries and more specifically to particulate electroactive materials suitable for use as anode active materials in metal-ion batteries. Also provided are methods for the preparation of the particulate electroactive materials of the invention.

Rechargeable metal-ion batteries are widely used in portable electronic devices such as mobile telephones and laptops and are finding increasing application in electric or hybrid vehicles. Rechargeable metal-ion batteries generally comprise an anode layer, a cathode layer, an electrolyte to transport metal ions between the anode and cathode layers, and a porous plastic spacer disposed between the anode and the cathode. The cathode typically comprises a metal current collector provided with a layer of metal ion containing metal oxide based composite, and the anode typically comprises a metal current collector provided with a layer of an electroactive material, defined herein as a material which is capable of inserting and releasing metal ions during the charging and discharging of a battery. For the avoidance of doubt, the terms “cathode” and “anode” are used herein in the sense that the battery is placed across a load, such that the cathode is the positive electrode and the anode is the negative electrode. When a metal-ion battery is charged, metal ions are transported from the metal-ion-containing cathode layer via the electrolyte to the anode and are inserted into the anode material. The term “battery” is used herein to refer both to a device containing a single anode and a single cathode and to devices containing a plurality of anodes and/or a plurality of cathodes.

There is interest in improving the gravimetric and/or volumetric capacities of rechargeable metal-ion batteries. The use of lithium-ion batteries has already provided a substantial improvement when compared to other battery technologies, but there remains scope for further development.

To date, commercial metal-ion batteries have largely been limited to the use of graphite as an anode active material. When a graphite anode is charged, lithium intercalates between the graphite layers to form a material with the empirical formula LiₓC₆ (wherein x is greater than 0 and less than or equal to 1). Consequently, graphite has a maximum theoretical capacity of 372 mAh/g in a lithium-ion battery, with a practical capacity that is somewhat lower (ca. 340 to 360 mAh/g). Other materials, such as silicon, tin and germanium, are capable of intercalating lithium with a significantly higher capacity than graphite but have yet to find widespread commercial use due to difficulties in maintaining sufficient capacity over numerous charge/discharge cycles.

Silicon in particular is attracting increasing attention as a potential alternative to graphite for the manufacture of rechargeable metal-ion batteries having high gravimetric and volumetric capacities because of its very high capacity for lithium (see, for example, Insertion Electrode Materials for Rechargeable Lithium Batteries, Winter, M. et al. in Adv. Mater. 1998, 10, No. 10). Silicon has a theoretical capacity in a lithium-ion battery of about 4,200 mAh/g (based on Li_{4.4}Si). However its use as an anode material is complicated by large volumetric changes on charging and discharging. Intercalation of lithium into bulk silicon leads to an increase in the volume of the anode material of up to 400% when silicon is lithiated to its maximum capacity, and repeated charge-discharge cycles cause significant mechanical strain in the silicon material, resulting in fracturing and delamination of the silicon anode material. Loss of electrical contact between the anode material and the current collector results in a significant loss of capacity in subsequent charge-discharge cycles.

The use of germanium as an anode active material is associated with similar problems. Germanium has a maximum theoretical capacity of 1625 mAh/g in a lithium-ion battery. However, intercalation of lithium into bulk germanium results in a volume change of up to 370% when germanium is lithiated to its maximum capacity. As with silicon, the mechanical strain on the germanium material results in fracturing and delamination of the anode material and a loss of capacity.

A number of approaches have been proposed to overcome the problems associated with the volume change observed when charging silicon-containing anodes. These relate in general to silicon structures which are better able to tolerate volumetric changes than bulk silicon. For example, Ohara et al. (Journal of Power Sources 136 (2004) 303-306) have described the evaporation of silicon onto a nickel foil current collector as a thin film and the use of this structure as the anode of a lithium-ion battery. Although this approach gives good capacity retention, the thin film structures do not give useful amounts of capacity per unit area, and any improvement is eliminated when the film thickness is increased. WO 2007/083155 discloses that improved capacity retention may be obtained through the use of silicon particles having high aspect ratio, i.e. the ratio of the largest dimension to the smallest dimension of the particle. The high aspect ratio, which may be as high as 100:1 or more, is thought to help to accommodate the large volume changes during charging and discharging without compromising the physical integrity of the particles.

Other approaches relate to the use of silicon structures that include void space to provide a buffer zone for the expansion that occurs when lithium is intercalated into silicon. For example, U.S. Pat. No. 6,334,939 and U.S. Pat. No. 6,514,395 disclose silicon based nano-structures for use as anode materials in lithium ion secondary batteries. Such nano-structures include cage-like spherical particles and rods or wires having diameters in the range 1 to 50 nm and lengths in the range 500 nm to 10 μm. WO 2012/175998 discloses particles comprising a plurality of silicon-containing pillars extending from a particle core which may be formed, for example, by chemical etching or by a sputtering process.

Porous silicon particles have also been investigated for use in lithium-ion batteries. Porous silicon particles are attractive candidates for use in metal-ion batteries as the cost of preparing these particles is generally less than the cost of manufacturing alternative silicon structures such as silicon fibres, ribbons or pillared particles. For example, US 2009/0186267 discloses an anode material for a lithium-ion battery, the anode material comprising porous silicon particles dispersed in a conductive matrix. The porous silicon particles have a diameter in the range 1 to 10 μm, pore diameters in the range 1 to 100 nm, a BET surface area in the range 140 to 250 m²/g and crystallite sizes in the range 1 to 20 nm. The porous silicon particles are mixed with a conductive material such as carbon black and a binder such as PVDF to form an electrode material which can be applied to a current collector to provide an electrode.

U.S. Pat. No. 7,479,351 discloses porous silicon-containing particles containing microcrystalline silicon and having a particle diameter in the range of 0.2 to 50 μm. The particles are obtained by alloying silicon with an element X selected from the group consisting of Al, B, P, Ge, Sn, Pb, Ni, Co, Mn, Mo, Cr, V, Cu, Fe, W, Ti, Zn, alkali metals, alkaline earth metals and combinations thereof, followed by removal of the element X by a chemical treatment.

Despite the efforts to date, known porous silicon materials do not meet the performance criteria required of electroactive materials commercially viable lithium ion batteries. In particular, the electroactive material must provide sufficient capacity retention over the lifetime of the battery, and it is this criterion that has received most attention from researchers over recent years. However, the lifetime performance of the electroactive material must be accompanied by handling properties which enable the electroactive material to be processed into an electrode layer. For instance, the electroactive material must retain its structural integrity during electrode manufacture, in particular during steps such as heat treatment and calendering of electrode active layers as are conventional in the art. In addition, the electroactive material must be readily dispersible into slurries in order that it may be distributed evenly in an electrode layer. In known porous silicon materials, it has been found that as capacity retention is improved, the processability of the porous silicon material deteriorates. This is usually because it is excessively fragile and disintegrates and/or because it forms agglomerates in slurries.

Accordingly, there remains a need in the art to identify porous electroactive materials, such as porous silicon materials, in which the lifetime performance of the electroactive material does not compromise the handling properties of the electroactive material. Such materials would have the capability to be repeated lithiated to their maximum capacity with minimal outward expansion and without fracturing, while also allowing good access of the electrolyte to the interior of the particles.

US 2004/0214085 discloses a rechargeable lithium battery in which the negative anode active material includes an aggregate of porous silicon particles wherein the porous particles are formed with a plurality of voids having an average diameter of between 1 nm and 10 μm and wherein the aggregate has an average particle size of between 1 μm and 100 μm. The particles are prepared via the etching of an alloy having a high content (e.g. 50 to 70 wt %) of silicon. This results in porous silicon particles having inadequate void space to accommodate the expansion of the silicon during charge-discharge cycling. Furthermore, the high content of silicon in the alloy results in the formation of silicon structures within the particles which are excessively large and undergo significant mechanical stress during charging and discharging. Together, these two factors result in a material which does not have sufficient lifetime.

In a first aspect, the present invention provides a particulate material consisting of a plurality of porous particles comprising an electroactive material selected from silicon, germanium or a mixture thereof, wherein the porous particles have a D₅₀ particle diameter in the range of greater than 5 to 25 μm, an intra-particle porosity in the range of from 30 to 90%, and a pore diameter distribution having a peak in the range of from 50 to less than 400 nm as determined by mercury porosimetry.

It has been found that the particulate material of the invention has particularly advantageous properties for use in metal-ion batteries. The porosity of the particles provides void space to accommodate expansion of the electroactive material during intercalation of metal ions, thereby avoiding excessive expansion of the electrode layer. This porosity is associated with a pore diameter distribution which ensures that the electroactive material structures in the particles are neither so fine as to be degraded during processing into electrode layers nor so large as to undergo unacceptable stress during charging and discharging of the electroactive material. In this respect, the size and location of the pores in relation to the electroactive structures is important to enable the expansion to occur into spaces between the electroactive structures whilst avoiding the presence of excess void spaces which would reduce the overall volumetric energy capacity of the lithiated particles. Thus, the porous particles of the invention are sufficiently robust to survive manufacture and incorporation into an anode layer without loss of structural integrity, particularly when anode layers are calendered to produce a dense uniform layer as is conventional in the art, while also providing reversible capacity over multiple charge-discharge cycles at a level which is commercially acceptable.

The inventors have further identified that the size of the porous particles enables the particles to be dispersed readily and without agglomeration in slurries, facilitating their incorporation into electrode layers.

Silicon and germanium may be present in combination with their oxides, for example due to the presence of a native oxide layer. As used herein, references to silicon and germanium shall be understood to include the oxides of silicon and germanium. Preferably, the oxides are present in an amount of no more than 30 wt %, more preferably no more than 25 wt %, more preferably no more than 20 wt %, more preferably no more than 15 wt %, more preferably no more than 10 wt %, more preferably no more than 5 wt %, for example no more than 4 wt %, no more than 3 wt %, no more than 2 wt % or no more than 1 wt %, based on the total amount of silicon and/or germanium and the oxides thereof.

The particulate material of the invention preferably comprises at least 60 wt %, more preferably at least 70 wt %, more preferably at least 75 wt %, more preferably at least 80 wt %, and most preferably at least 85 wt % of the electroactive material. For example, the particulate material of the invention may comprise at least 90 wt %, at least 95 wt %, at least 98 wt % or at least 99 wt % of the electroactive material.

A preferred component of the electroactive material is silicon. Thus, the particulate material of the invention preferably comprises at least 60 wt %, more preferably at least 70 wt %, more preferably at least 75 wt %, more preferably at least 80 wt %, and most preferably at least 85 wt % of silicon. For example, the particulate material of the invention may comprise at least 90 wt %, at least 95 wt %, at least 98 wt % or at least 99 wt % of silicon.

The electroactive material preferably comprises at least 90 wt %, more preferably at least 95 wt %, more preferably at least 98 wt %, more preferably at least 99 wt % silicon. For example, the electroactive material may consist essentially of silicon.

The particulate material of the invention may optionally comprise a minor amount of one or more additional elements other than silicon or germanium. For instance, the particulate material may comprise a minor amount of one or more additional elements selected from, Al, Sb, Cu, Mg, Zn, Mn, Cr, Co, Mo, Ni, Be, Zr, Fe, Na, Sr, P, Sn, Ru, Ag, Au and oxides thereof. Preferably the one or more additional elements, if present, are selected from one or more of Al, Ni, Ag and Cu, and most preferably Al. The one or more additional elements are preferably present in a total amount of no more than 40 wt %, more preferably no more than 30 wt %, more preferably no more than 25 wt %, more preferably no more than 20 wt %, more preferably no more than 15 wt %, more preferably no more than 10 wt %, and most preferably no more than 5 wt %, based on the total weight of the particulate material. Optionally, the one or more additional elements may be present in a total amount of at least 0.01 wt %, at least 0.05 wt %, at least 0.1 wt %, at least 0.2 wt %, at least 0.5 wt %, at least 1 wt %, at least 2 wt %, or at least 3 wt %, based on the total weight of the particulate material.

In some embodiments, the particulate material of the invention may comprise silicon and a minor amount of aluminium. For instance, the particulate material may comprise at least 60 wt % silicon and up to 40 wt % aluminium, more preferably at least 70 wt % silicon and up to 30 wt % aluminium, more preferably at least 75 wt % silicon and up to 25 wt % aluminium, more preferably at least 80 wt % silicon and up to 20 wt % aluminium, more preferably at least 85 wt % silicon and up to 15 wt % aluminium, more preferably at least 90 wt % silicon and up to 10 wt % aluminium, more preferably at least 95 wt % silicon and up to 5 wt % aluminium, and most preferably at least 98 wt % silicon and up to 2 wt % aluminium. Optionally, the particulate material may comprise at least 0.01 wt % aluminium, at least 0.1 wt % aluminium, at least 0.5 wt % aluminium, at least 1 wt % aluminium, at least 2 wt % aluminium, or at least 3 wt % aluminium.

The porous particles have a D₅₀ particle diameter in the range of from greater than 5 to 25 μm. Optionally, the D₅₀ particle diameter may be at least 6 μm, at least 7 μm, at least 8 μm, or at least 10 μm. Optionally, the D₅₀ particle diameter may be no more than 20 μm, no more than 18 μm, no more than 15 μm, or no more than 12 μm. It has been found that particles within this size range and having porosity and a pore diameter distribution as set out herein are ideally suited for use in anodes for metal-ion batteries, due to their dispersibility in slurries, their structural robustness, their capacity retention over repeated charge-discharge cycles, and their suitability for forming dense electrode layers of uniform thickness in the conventional range of from 20 to 50 μm.

The D₁₀ particle diameter of the porous particles is preferably at least 1 μm, more preferably at least 2 μm, and still more preferably at least 3 μm. By maintaining the D₁₀ particle diameter at 1 μm or more, the potential for undesirable agglomeration of sub-micron sized particles is reduced, resulting in improved dispersibility of the particulate material and improved capacity retention. Furthermore, it is found that very small particles have a pore structure which is sub-optimal for use in metal-ion cells. Thus, by maintaining the D₁₀ particle diameter at 1 μm or more, the amount of such particles is controlled below acceptable limits.

The D₉₀ particle diameter of the porous particles is preferably no more than 40 μm, more preferably no more than 30 μm, more preferably no more than 25 μm, and most preferably no more than 20 μm. It has been found that larger particles having a size above 40 μm may be less physically robust and less resistant to mechanical stress during repeated charging and discharging cycles. In addition, larger particles are less suitable for forming dense electrode layers, particularly electrode layers having a thickness in the range of from 20 to 50 μm.

The D₉₉ particle diameter of the porous particles is preferably no more than 50 μm, more preferably no more than 40 μm, more preferably no more than 30 μm, and most preferably no more than 25 μm.

Preferably, the porous particles have a narrow size distribution span. For instance, the particle size distribution span (defined as (D₉₀−D₁₀)/D₅₀) is preferably 5 or less, more preferably 4 or less, more preferably 3 or less, more preferably 2 or less and most preferably 1.5 or less. By maintaining a narrow size distribution span, the concentration of particles in the size range found by the inventors to be most favourable for use in electrodes is maximised.

For the avoidance of doubt, the term “particle diameter” as used herein refers to the equivalent spherical diameter (esd), i.e. the diameter of a sphere having the same volume as a given particle, wherein the particle volume is understood to include the volume of the intra-particle pores. The terms “D₅₀” and “D₅₀ particle diameter” as used herein refer to the volume-based median particle diameter, i.e. the diameter below which 50% by volume of the particle population is found. The terms “D₁₀” and “D₁₀ particle diameter” as used herein refer to the 10th percentile volume-based median particle diameter, i.e. the diameter below which 10% by volume of the particle population is found. The terms “D₉₀” and “D₉₀ particle diameter” as used herein refer to the 90th percentile volume-based median particle diameter, i.e. the diameter below which 90% by volume of the particle population is found. The terms “D₉₉” and “D₉₉ particle diameter” as used herein refer to the 99th percentile volume-based median particle diameter, i.e. the diameter below which 99% by volume of the particle population is found.

Particle diameters and particle size distributions can be determined by routine laser diffraction techniques. Laser diffraction relies on the principle that a particle will scatter light at an angle that varies depending on the size the particle and a collection of particles will produce a pattern of scattered light defined by intensity and angle that can be correlated to a particle size distribution. A number of laser diffraction instruments are commercially available for the rapid and reliable determination of particle size distributions. Unless stated otherwise, particle size distribution measurements as specified or reported herein are as measured by the conventional Malvern Mastersizer 2000 particle size analyzer from Malvern Instruments. The Malvern Mastersizer 2000 particle size analyzer operates by projecting a helium-neon gas laser beam through a transparent cell containing the particles of interest suspended in an aqueous solution. Light rays which strike the particles are scattered through angles which are inversely proportional to the particle size and a photodetector array measures the intensity of light at several predetermined angles and the measured intensities at different angles are processed by a computer using standard theoretical principles to determine the particle size distribution. Laser diffraction values as reported herein are obtained using a wet dispersion of the particles in distilled water. The particle refractive index is taken to be 3.50 and the dispersant index is taken to be 1.330. Particle size distributions are calculated using the Mie scattering model.

As used herein, the term “porous particle” shall be understood as referring to a particle comprising a plurality of pores, voids or channels within a particle structure. The term “porous particle” shall be understood in particular to include particles comprising a random or ordered network of linear, branched or layered elongate structural elements, wherein interconnected void spaces or channels are defined between the elongate structural elements of the network, the elongate structural elements suitably including linear, branched or layered fibres, tubes, wires, pillars, rods, ribbons, plates or flakes. Preferably the porous particles have a substantially open porous structure such that substantially all of the pore volume of the porous particles is accessible to a fluid from the exterior of the particle, for instance to a gas or to an electrolyte. By a substantially open porous structure, it is meant that at least 90%, preferably at least 95%, preferably at least 98%, preferably at least 99% of the pore volume of the porous particles is accessible from the exterior of the particles.

The intra-particle porosity of the porous particles should be distinguished from the inter-particle porosity of the particulate material of the invention. Intra-particle porosity is defined by the ratio of the volume of pores within a particle to the total volume of the particle. Inter-particle porosity is the volume of pores between discrete particles within a powder sample of said discrete particles and is a function both of the size of the individual particles and of the packing density of the particulate material. The total porosity of the particulate material may be defined as the sum of the intra-particle and inter-particle porosity.

The intra-particle porosity of the porous particles is preferably at least 40%, preferably at least 50%, and most preferably at least 60%. The intra-particle porosity is preferably no more than 87%, more preferably no more than 86%, more preferably no more than 85%, more preferably no more than 80%, and most preferably no more than 75%.

Where the porous particles are prepared by removal of an unwanted component from a starting material, e.g. by leaching of an alloy as discussed in further detail below, the intra-particle porosity can suitably be determined by determining the elemental composition of the particles before and after leaching and calculating the volume of material that is removed.

More preferably, the intra-particle porosity of the porous particles may be measured by mercury porosimetry. Mercury porosimetry is a technique that characterises the porosity of a material by applying varying levels of pressure to a sample of the material immersed in mercury. The pressure required to intrude mercury into the pores of the sample is inversely proportional to the size of the pores. More specifically, mercury porosimetry is based on the capillary law governing liquid penetration into small pores. This law, in the case of a non-wetting liquid such as mercury, is expressed by the Washburn equation:

D=(1/P)·4γ·cos φ

wherein D is pore diameter, P is the applied pressure, γ is the surface tension, and φ is the contact angle between the liquid and the sample. The volume of mercury penetrating the pores of the sample is measured directly as a function of the applied pressure. As pressure increases during an analysis, pore size is calculated for each pressure point and the corresponding volume of mercury required to fill these pores is measured. These measurements, taken over a range of pressures, give the pore volume versus pore diameter distribution for the sample material. The Washburn equation assumes that all pores are cylindrical. While true cylindrical pores are rarely encountered in real materials, this assumption provides sufficiently useful representation of the pore structure for most materials. For the avoidance of doubt, references herein to pore diameter shall be understood as referring to the equivalent cylindrical dimensions as determined by mercury porosimetry. Values obtained by mercury porosimetry as reported herein are obtained in accordance with ASTM UOP574-11, with the surface tension γ taken to be 480 mN/m and the contact angle φ taken to be 140° for mercury at room temperature. The density of mercury is taken to be 13.5462 g/cm³ at room temperature.

For a sample in the form of a powder of porous particles, the total pore volume of the sample is the sum of intra-particle and inter-particle pores. This gives rise to an at least bimodal pore diameter distribution curve in a mercury porosimetry analysis, comprising a set of one or more peaks at lower pore sizes relating to the intra-particle pore diameter distribution and set of one or more peaks at larger pore sizes relating to the inter-particle pore diameter distribution. From the pore diameter distribution curve, the lowest point between the two sets of peaks indicates the diameter at which the intra-particle and inter-particle pore volumes can be separated. The pore volume at diameters greater than this is assumed to be the pore volume associated with inter-particle pores. The total pore volume minus the inter-particle pore volume gives the intra-particle pore volume from which the intra-particle porosity can be calculated.

A number of high precision mercury porosimetry instruments are commercially available, such as the AutoPore IV series of automated mercury porosimeters available from Micromeritics Instrument Corporation, USA. For a complete review of mercury porosimetry reference may be made to P. A. Webb and C. Orr in “Analytical Methods in Fine Particle Technology, 1997, Micromeritics Instrument Corporation, ISBN 0-9656783-0.

It will be appreciated that mercury porosimetry and other intrusion techniques are effective only to determine the pore volume of pores that are accessible to mercury (or another fluid) from the exterior of the porous particles to be measured. As noted above, substantially all of the pore volume of the particles of the invention is accessible from the exterior of the particles, and thus porosity measurements by mercury porosimetry will generally be equivalent to the entire pore volume of the particles. Nonetheless, for the avoidance of doubt, intra-particle porosity values as specified or reported herein shall be understood as referring to the volume of open pores, i.e. pores that are accessible to a fluid from the exterior of the particles of the invention. Fully enclosed pores which cannot be identified by mercury porosimetry shall not be taken into account herein when specifying or reporting intra-particle porosity values.

The particulate material of the invention is characterised by having at least two peaks in the pore diameter distribution as determined by mercury porosimetry, at least one peak at lower pore size being associated with intra-particle pores and at least one peak at higher pore size being associated with inter-particle porosity. The particulate material of the invention preferably has a pore diameter distribution having at least one peak at a pore size less than 380 nm, more preferably less than 360 nm, and most preferably less than 350 nm as determined by mercury porosimetry. Preferably, the pore diameter distribution has at least one peak at a pore size of more than 60 nm, more preferably more than 80 nm, more preferably more than 100 nm, as determined by mercury porosimetry.

Preferably, the particulate material of the invention is also characterised by a peak in the pore diameter distribution of a loose packed plurality of particles relating to the inter-particle porosity at a pore size in the range of from 1000 nm to 4000 nm, as determined by mercury porosimetry.

In some embodiments, the particulate material of the invention may be characterised by the presence of particles comprising at least one pore, void or channel (accessible by electrolyte) having at least three dimensions of at least 150 nm. Preferably, the at least one pore, void or channel opens onto an external surface of the particulate material and connects with an internal network of voids and channels to enable access of an electrolyte solution into the centre of the particulate material. It is believed that such a pores, voids and channels of this type facilitate more uniform insertion and extraction of metal ions throughout the bulk of the particulate material, improving charge/discharge efficiency and enhancing charge/discharge rates.

The inventors have found that particles having peaks in the pore diameter distribution within these ranges and a porosity as set out above demonstrate particularly good charge-discharge cycling properties when used as electroactive materials in anodes for metal-ion batteries. Without being bound by theory, it is believed that the particulate material of the invention provides an optimum balance between overall porosity and pore size, thus providing sufficient void space within the particles to allow for inward expansion of the electroactive material during intercalation of metal ions, whilst also ensuring that the electroactive material architecture within the particles is sufficiently robust to withstand the mechanical strain during charging of the electroactive material to its maximum capacity and mechanical damage during particle manufacture and electrode assembly.

The porous particles are preferably spheroidal in shape. Spheroidal particles as defined herein may include both spherical and ellipsoidal particles and the shape of the particles of the invention may suitably be defined by reference to the sphericity and the aspect ratio of the particles of the invention. Spheroidal particles are found to be particularly well-suited to dispersion in slurries without the formation of agglomerates, particularly when the spheroidal particles have particle sizes falling within the ranges defined herein. In addition, the use of porous spheroidal particles is surprisingly found to provide a further improvement in capacity retention when compared to porous particles and porous particle fragments of more irregular morphology.

The sphericity of an object is conventionally defined as the ratio of the surface area of a sphere to the surface area of the object, wherein the object and the sphere have identical volume. However, in practice it is difficult to measure the surface area and volume of individual particles at the micron scale. However, it is possible to obtain highly accurate two-dimensional projections of micron scale particles by scanning electron microscopy (SEM) and by dynamic image analysis, in which a digital camera is used to record the shadow projected by a particle. The term “sphericity” as used herein shall be understood as the ratio of the area of the particle projection to the area of a circle, wherein the particle projection and circle have identical circumference. Thus, for an individual particle, the sphericity S may be defined as:

$$S = \frac{4 \cdot π \cdot {A}_{m}}{{( {C}_{m} )}^{2}}$$

wherein Aₘ is the measured area of the particle projection and Cₘ is the measured circumference of the particle projection. The average sphericity Sₐᵥ of a population of particles as used herein is defined as:

$${S}_{av} = \frac{1}{n} {\sum }_{i = 1}^{n} [ \frac{4 \cdot π \cdot {A}_{m}}{{( {C}_{m} )}^{2}} ]$$

wherein n represents the number of particles in the population.

As used herein, the term “spheroidal” as applied to the particles of the invention shall be understood to refer to a material having an average sphericity of at least 0.70. Preferably, the porous spheroidal particles of the invention have an average sphericity of at least 0.85, more preferably at least 0.90, more preferably at least 0.92, more preferably at least 0.93, more preferably at least 0.94, more preferably at least 0.95, more preferably at least 0.96, more preferably at least 0.97, more preferably at least 0.98 and most preferably at least 0.99.

The average aspect ratio of the porous particles is preferably less than 3:1, more preferably no more than 2.5:1, more preferably no more than 2:1, more preferably no more than 1.8:1, more preferably no more than 1.6:1, more preferably no more than 1.4:1 and most preferably no more than 1.2:1. As used herein, the term “aspect ratio” refers to the ratio of the longest dimension to the shortest dimension of a two-dimensional particle projection. The term “average aspect ratio” refers to a number-weighted mean average of the aspect ratios of the individual particles in the particle population.

It will be understood that the circumference and area of a two-dimensional particle projection will depend on the orientation of the particle in the case of any particle which is not perfectly spheroidal. However, the effect of particle orientation may be offset by reporting sphericity and aspect ratios as average values obtained from a plurality of particles having random orientation.

A number of SEM and dynamic image analysis instruments are commercially available, allowing the sphericity and aspect ratio of a particulate material to be determined rapidly and reliably. Unless stated otherwise, sphericity values as specified or reported herein are as measured by a CamSizer XT particle analyzer from Retsch Technology GmbH. The CamSizer XT is a dynamic image analysis instrument which is capable of obtaining highly accurate distributions of the size and shape for particulate materials in sample volumes of from 100 mg to 100 g, allowing properties such as average sphericity and aspect ratios to be calculated directly by the instrument.

The particulate material of the invention preferably has a BET surface area of less than 300 m²/g, more preferably less than 200 m²/g, more preferably less than 150 m²/g, more preferably less than 120 m²/g. The particulate material of the invention may have a BET surface area of less than 100 m²/g, for example less than 80 m²/g. Suitably, the BET surface may be at least 10 m²/g, at least 15 m²/g, at least 20 m²/g, or at least 50 m²/g. The term “BET surface area” as used herein should be taken to refer to the surface area per unit mass calculated from a measurement of the physical adsorption of gas molecules on a solid surface, using the Brunauer-Emmett-Teller theory, in accordance with ASTM B922/10.

Control of the BET surface area of electroactive material is an important consideration in the design of anodes for metal ion batteries. A BET surface area which is too low results in unacceptably low charging rate and capacity due to the inaccessibility of the bulk of the electroactive material to metal ions in the surrounding electrolyte. However, a very high BET surface area is also known to be disadvantageous due to the formation of a solid electrolyte interphase (SEI) layer at the anode surface during the first charge-discharge cycle of the battery. SEI layers are formed due to reaction of the electrolyte at the surface of electroactive materials and can consume significant amounts of metal ions from the electrolyte, thus depleting the capacity of the battery in subsequent charge-discharge cycles. While previous teaching in the art focuses on an optimum BET surface area below about 10 m²/g, the present inventors have found that a much wider BET range can be tolerated when using the particulate material of the invention as an electroactive material, even when the particulate material comprises the majority of the electroactive material in the electrode, for example at least 50 wt % of the total electroactive material.

The particulate material of the invention may be distinguished in some embodiments by a specific microstructure of the structural elements that constitute the porous particles of the particulate material and their relationship with an interconnected pore network of the porous particles. Preferably, the porous particles comprise a network of interconnected irregular elongate structural elements comprising the electroactive material which may be described as acicular, flake-like, dendritic, or coral-like. This particle architecture is associated with an interconnected network of pores, preferably with a substantially even distribution of the pores throughout the particle, such that the spacing between the neighbouring structural elements is large enough to accommodate expansion from all structural elements bounding the pore space. At the same time, the particles comprise sufficiently large pore spaces connected to the outer surface of the particle to enable easy transport of an electrolyte into the central regions of the particle during the lithiation and delithiation cycle. In preferred embodiments, the porous particles comprise networks of fine structural elements having an aspect ratio of at least 2:1 and more preferably at least 5:1. A high aspect ratio of the structural elements provides a high number of interconnections between the structural elements constituting the porous particles for electrical continuity.

The thickness of the structural elements constituting the porous particles is an important parameter in relation to the ability of the electroactive material to reversibly intercalate and release metal ions. Structural elements which are too thin may result in excessive first cycle loss due to excessively high BET surface area the resulting formation of an SEI layer. However, structural elements which are too thick are placed under excessive stress during intercalation of metal ions and also impede the insertion of metal ions into the bulk of the silicon material. The particulate material of the invention provides an optimum balance of these competing factors due to the presence of structural elements of optimised size and proportions. Thus, the porous particles preferably comprise structural elements having a smallest dimension less than 300 nm, preferably less than 200 nm, more preferably less than 150 nm, and a largest dimension at least twice, and preferably at least five times the smallest dimension. The smallest dimension is preferably at least 10 nm, more preferably at least 20 nm, and most preferably at least 30 nm.

The electroactive material containing structural elements constituting the porous particles preferably comprises amorphous or nanocrystalline material having a crystallite size of less than 100 nm, preferably less than 60 nm. The structural elements may comprise a mixture of amorphous and nanocrystalline electroactive material. The crystallite size may be determined by X-ray diffraction spectrometry analysis using an X-ray wavelength of 1.5456 nm. The crystallite size is calculated using the Scherrer equation from a 2θ XRD scan, where the crystallite size d=K·λ/(B·Cos θ_{B}), the shape constant K is taken to be 0.94, the wavelength λ is 1.5456 nm, θ_{B} is the Bragg angle associated with the 220 silicon peak, and B is the full width half maximum (FWHM) of that peak. Preferably the crystallite size is at least 10 nm.

The particulate material of the invention may suitably be obtained by processes in which unwanted material is removed from a particulate starting material comprising the electroactive material. Removal of unwanted material may create or expose the electroactive material structures defining the porous particles. For example, this may involve the removal of oxide components from a silicon or germanium structure, the etching of bulk silicon or germanium particles, or the leaching of a metal matrix from alloy particles containing electroactive material structures in a metal matrix.

The particulate material of the invention is preferably obtained by a process comprising leaching particles of an alloy comprising silicon and/or germanium in a metal matrix. This process relies on the observation that a network of crystalline silicon and/or germanium structures is precipitated within an alloy matrix when certain alloys containing these elements are cooled from the molten state. Suitably, the alloys comprise matrix metals in which the solubility of silicon and/or germanium is low and/or in which the formation of intermetallics on cooling is negligible or non-existent. Leaching of the metals constituting the metal matrix exposes the network of silicon and/or germanium structures. Thus, leaching particles of an alloy comprising silicon and/or germanium provides a suitable route to the porous particles defined above.

Accordingly, in a second aspect, the present invention provides a process for the preparation of a particulate material consisting of a plurality of porous particles comprising an electroactive material, the process comprising the steps of:
(a) providing a plurality of alloy particles, wherein the alloy particles are obtained by cooling a molten alloy comprising: (i) from 11 to 45 wt % of an electroactive material component selected from silicon, germanium and mixtures thereof; and (ii) a matrix metal component, wherein said alloy particles have a D₅₀ particle diameter in the range of greater than 5 to 25 μm, and wherein said alloy particles comprise discrete electroactive material containing structures dispersed in the matrix metal component;
(b) leaching the alloy particles from step (a) to remove at least a portion of the matrix metal component and to at least partially expose the electroactive material containing structures;
wherein the porous particles comprise no more than 40% by weight of the matrix metal component.

This aspect of the invention relies on the observation that crystalline electroactive material containing structures are precipitated within a matrix metal component when certain alloys are cooled. These alloys are those in which the solubility of the electroactive materials in the material metal is low and in which there is little or no formation of intermetallics on cooling. By controlling the concentration of the electroactive material in the alloy in the range specified above, it is found that a particulate material is obtained having porosity and other structural properties that are particularly suitable for use in anodes for lithium ion batteries, particularly anodes comprising a relatively large amount of silicon-based electroactive material.

The alloy particles have a D₅₀ particle diameter in the range of from greater than 5 to 25 μm. Preferably, the D₅₀ particle diameter may be at least 6 μm, more preferably at least 7 μm, more preferably at least 8 μm, and most preferably at least 10 μm. Preferably, the D₅₀ particle diameter may be no more than 20 μm, more preferably no more than 18 μm, more preferably no more than 15 μm, and most preferably no more than 12 μm.

The alloy particles preferably have a D₁₀ particle diameter of at least 1 μm, more preferably at least 2 μm, and still more preferably at least 3 μm.

The alloy particles preferably have a D₉₀ particle diameter of no more than 40 μm, more preferably no more than 30 μm, more preferably no more than 25 μm, and most preferably no more than 20 μm.

The alloy particles preferably have a D₉₉ particle diameter of no more than 50 μm, more preferably no more than 40 μm, more preferably no more than 30 μm, and most preferably no more than 25 μm.

The alloy particles preferably have a narrow size distribution span. Preferably, the particle size distribution span (defined as (D₉₀−D₁₀)/D₅₀) of the alloy particles is 5 or less, more preferably 4 or less, more preferably 3 or less, and most preferably 2 or less, and most preferably 1.5 or less.

The alloy particles are preferably spheroidal particles. Thus, the alloy particles preferably have an average sphericity of at least 0.70, more preferably at least 0.85, more preferably at least 0.90, more preferably at least 0.92, more preferably at least 0.93, more preferably at least 0.94, more preferably at least 0.95, more preferably at least 0.96, more preferably at least 0.97, more preferably at least 0.98, and most preferably at least 0.99.

The average aspect ratio of the alloy particles is preferably less than 3:1, more preferably no more than 2.5:1, more preferably no more than 2:1, more preferably no more than 1.8:1, more preferably no more than 1.6:1, more preferably no more than 1.4:1 and most preferably no more than 1.2:1.

A preferred component of the electroactive material is silicon. Thus, the electroactive material component of the alloy particles preferably comprises at least 90 wt %, more preferably at least 95 wt %, more preferably at least 98 wt %, more preferably at least 99 wt % silicon.

The alloy particles preferably comprise at least 11.2 wt %, more preferably at least 11.5 wt %, more preferably at least 11.8 wt %, more preferably at least 12 wt %, and most preferably at least 12.2 wt % of the electroactive material component. For example, the alloy particles may comprise at least 12.4 wt %, more preferably at least 12.6 wt %, more preferably at least 12.8 wt %, and most preferably at least 13 wt % of the electroactive material component. Preferably the alloy particles comprise less than 40 wt %, preferably less than 35 wt %, more preferably less than 30 wt %, more preferably less than 25 wt %, more preferably less than 20 wt %, and most preferably less than 18 wt % of the electroactive material component. The amount of electroactive material in the alloy particles is of course dictated by the desired structure of the porous particles, including the desired porosity and pore diameter distribution of the porous particles, and the dimension of the structural elements.

The matrix metal component is suitably selected from Al, Sb, Cu, Mg, Zn, Mn, Cr, Co, Mo, Ni, Be, Zr, Fe, Sn, Ru, Ag, Au and combinations thereof. Preferably, the matrix metal component comprises one or more of Al, Ni, Ag or Cu. More preferably, the matrix metal component comprises at least 50 wt %, more preferably at least 60 wt %, more preferably at least 70 wt %, more preferably at least 80 wt %, more preferably at least 90 wt % and most preferably at least 95 wt % of one or more of Al, Ni, Ag or Cu.

A preferred matrix metal component is aluminium. Thus, the matrix metal component may be aluminium, or a combination of aluminium with one or more additional metals or rare earths, for example one or more of Sb, Cu, Mg, Zn, Mn, Cr, Co, Mo, Ni, Be, Zr, Fe, Na, Sr, P, Sn, Ru, Ag and Au, wherein the combination comprises at least 50 wt %, more preferably at least 60 wt %, more preferably at least 70 wt %, more preferably at least 80 wt %, more preferably at least 90 wt %, more preferably at least 95 wt % aluminium. More preferably, the matrix metal component is selected from aluminium or a combination of aluminium with copper and/or silver and/or nickel, wherein the combination comprises at least 50 wt %, more preferably at least 60 wt %, more preferably at least 70 wt %, more preferably at least 80 wt %, more preferably at least 90 wt % and most preferably at least 95 wt % aluminium.

Preferably, the electroactive material is silicon or a combination of silicon and germanium, wherein the combination comprises at least 90 wt %, more preferably at least 95 wt %, more preferably at least 98 wt %, more preferably at least 99 wt % silicon and the matrix metal component is aluminium, or a combination of aluminium with one or more of Sb, Cu, Mg, Zn, Mn, Cr, Co, Mo, Ni, Be, Zr, Fe, Na, Sr, P, Sn, Ru, Ag and Au, wherein the combination comprises at least 90 wt %, more preferably at least 95 wt % aluminium.

Most preferably, the electroactive material is silicon and the matrix metal component is aluminium. Silicon-aluminium alloys are well-known in the field of metallurgy and have a range of useful properties, including excellent wear-resistance, cast-ability, weld-ability and low shrinkage. They are widely used in industry wherever these properties are desired, for instance as car engine blocks and cylinder heads. It has now been found that silicon-aluminium alloys are particularly useful for the preparation of the particulate material of the invention.

It will be appreciated that metallurgical-grade aluminium and silicon may comprise minor amounts of other elements as impurities, including those identified herein as optional components of the alloy particles. For the avoidance of doubt, where it is stated herein that the electroactive material is silicon and the matrix metal component is aluminium, it is not excluded that the alloy particles may comprise minor amounts of other elements, provided that the total amount of such additional elements is less than 5 wt %, more preferably 2 wt %, and most preferably less than 1 wt %. Amounts of electroactive materials as specified herein shall not be interpreted as including impurities.

Silicon has negligible solubility in solid aluminium and does not form intermetallics with aluminium. Thus, aluminium-silicon alloy particles comprise discrete silicon structures dispersed in an aluminium matrix. By maintaining the concentration of silicon in the alloy particles in the ranges set out herein, it is found that the porous particles obtained after leaching have a specific microstructure which is particularly advantageous for use in hybrid anodes for metal ion batteries.

The eutectic point of a silicon-aluminium alloy is at a concentration of ca. 12.6 wt % silicon. In the case of a silicon-aluminium alloy it has been found that the presence of silicon in an amount significantly above the eutectic composition may lead to the formation of larger silicon elements within the alloy particles. For instance, where the amount of silicon in the alloy particles is in the range of 20 to 30 wt %, and particularly in the range of 24 to 30 wt %, coarse primary phase silicon domains may be observed following leaching of the matrix metal component. The size of such primary phase structures is dependent on the cooling rate during solidification of the alloy and can also be modified by adding further known additives to the alloy. However, provided that the total amount of silicon in the alloy particles does not exceed 30 wt %, more preferably 24 wt %, it is considered that the overall microstructure of the porous particles will be sufficiently fine to provide acceptable capacity retention during charging and discharging of hybrid anodes comprising the particulate material of the invention.

The shape and distribution of the discrete electroactive material structures within the alloy particles is a function of both the composition of the alloy particles and the process by which the alloy particles are made. If the amount of electroactive material is too low, then it is found that the porous particles obtained after removal of the matrix metal component have poor structural integrity, and tend to disintegrate during manufacture and/or subsequent incorporation into anodes. In addition, the capacity retention of such particles may be inadequate for commercial applications due to insufficient resilience to the volumetric changes on charging and discharging.

The size and shape of the electroactive material structures may also be influenced by controlling the rate of cooling of the alloy from the melt and the presence of modifiers (chemical additives to the melt). In general, faster cooling will lead to the formation of smaller, more evenly distributed silicon structures. The rate of cooling, and thus the size and shape of the electroactive material structures formed, is a function of the process used to form the alloy particles. Thus, by the selection of an appropriate process for the formation of the alloy particles, alloy particles may be obtained in which the dispersed electroactive material structures have a morphology which, when exposed by leaching of the matrix metal, is particularly desirable for use in metal-ion batteries, in particular metal-ion batteries having hybrid electrodes.

The alloy particles used in the process of the invention are preferably obtained by cooling a molten alloy from the liquid state to the solid state at a cooling rate of at least 1×10³ K/s, preferably at least 5×10³ K/s, preferably at least 1×10⁴ K/s, more preferably at least 5×10⁴ K/s, for example at least 1×10⁵ K/s, or at least 5×10⁵ K/s, or at least 1×10⁶ K/s, or at least 5×10⁶ K/s, or at least 1×10⁷ K/s. It is found that the peak of the intra-particle pore diameter distribution of the porous particles obtained according to the process of the invention tends towards smaller pore sizes with increased cooling rates.

Processes for cooling a molten alloy to form alloy particles with a cooling rate of at least 10³ K/s include gas atomisation, water atomisation, melt-spinning, splat cooling and plasma phase atomisation. Preferred processes for cooling the molten alloy to form alloy particles include gas atomisation and water atomisation. It is found that the rate of cooling of the particles obtained by gas and water atomisation processes may be correlated to the size of the alloy particles, and alloy particles having a particle size as specified herein cool at very high rates (i.e. in excess of 1×10³ K/s, and typically at least 1×10⁵ K/s) and thus the electroactive material structures formed in the alloy particles have a morphology which is particularly preferred in accordance with the invention. If appropriate, the alloy particles obtained by any particular cooling method may be classified to obtain an appropriate size distribution.

The cooling rate of the particles obtained by gas atomisation may be correlated to the size of the alloy particles by a mathematical model that considers gas conductivity, melt heat capacity, particle diameter, and temperature difference between the melt and the environment (see Shiwen et al., Rare Metal Material and Engineering, 2009, 38(1), 353-356; and Mullis et al., Metallurgical and Materials Transactions B, 2013, 44(4), 992-999).

The metal matrix may be leached using any leachant which is suitable to remove at least a portion of the matrix metal component while leaving the electroactive material structures intact. Leachants may be liquid or gas phase and may include additives or sub-processes to remove any by-product build up which might impede etching. Leaching may suitably be carried out by a chemical or electrochemical process. Caustic leaching using sodium hydroxide may be used for leaching aluminium, although the concentration of sodium hydroxide in the leachant solution should be controlled below 10 to 20 wt % to avoid attack of silicon and/or germanium by the leachant. Acidic leaching, for instance using hydrochloric acid or ferric chloride, is also a suitable technique. Alternatively, the matrix metal may be leached electrochemically using salt electrolytes, e.g. copper sulfate or sodium chloride. Leaching is carried out until the desired porosity of the porous particles is achieved. For example, acid leaching using 6M aqueous HCl at room temperature for a period of from 10 to 60 minutes is sufficient to leach substantially all of the leachable aluminium from the silicon-aluminium alloys described herein (noting that a minor amount of the matrix metal may not be leached).

Following leaching of the matrix metal component, the porous particles will be formed intact in the leachant. In general, it is appropriate to carry out cleaning and rinsing steps so as to remove by-products and residual leachant. The fine distribution of the silicon structural elements in the alloy particles is such that the porous particles obtained after leaching have particle dimensions and shape which are substantially equal to the particle dimensions and shape of the starting alloy particles.

It is not essential that the matrix metal component be removed in its entirety and a minor amount of matrix metal may remain even with extended leaching reaction times. Indeed, it may be desirable that the matrix metal component is not completely removed, since it may function as an additional electroactive material and/or as a dopant. Thus, the particulate material obtained according to the process of the invention may comprise residual matrix metal component as defined above in an amount of no more than 40 wt %, preferably no more than 30 wt %, more preferably no more than 25 wt %, more preferably no more than 20 wt %, more preferably no more than 15 wt %, more preferably no more than 10 wt %, and most preferably no more than 5 wt %, relative to the total weight of the particulate material. Optionally, the particulate material obtained according to the process of the invention may comprise residual matrix metal component in an amount of at least 0.01 wt, at least 0.1 wt %, at least 0.5 wt %, at least 1 wt %, at least 2 wt %, or at least 3 wt %, relative to the total weight of the particulate material.

As discussed above, a preferred matrix metal component is aluminium, and thus the particulate material obtained according to the process of the invention may optionally comprise residual aluminium in an amount of no more than 40 wt %, more preferably no more than 30 wt %, more preferably no more than 25 wt %, more preferably no more than 20 wt %, more preferably no more than 15 wt %, more preferably no more than 10 wt %, and most preferably no more than 5 wt %, relative to the total weight of the particulate material. Optionally, the particulate material obtained according to the process of the invention may comprise residual aluminium in an amount of at least 0.01 wt, at least 0.1 wt %, at least 0.5 wt %, at least 1 wt %, at least 2 wt %, or at least 3 wt %, relative to the total weight of the particulate material. Residual aluminium is well-tolerated since it is itself capable of absorbing and releasing metal ions during charging and discharging of a metal-ion battery, and it may further aid in making electrical contact between the silicon structures and between the silicon structures and the anode current collector.

The particulate material obtained according to the process of the invention may comprise silicon and a minor amount of aluminium. For instance, the particulate material obtained according to the process of the invention may comprise at least 60 wt % silicon and no more than 40 wt % aluminium, more preferably at least 70 wt % silicon and no more than 30 wt % aluminium, more preferably at least 75 wt % silicon and no more than 25 wt % aluminium, more preferably at least 80 wt % silicon and no more than 20 wt % aluminium, more preferably at least 85 wt % silicon and no more than 15 wt % aluminium, more preferably at least 90 wt % silicon and no more than 10 wt % aluminium, and most preferably at least 95 wt % silicon and no more than 5 wt % aluminium.

Optionally, the particulate material may comprise at least 1 wt % aluminium and no more than 99 wt % silicon, or at least 2 wt % aluminium and no more than 98 wt % silicon, or at least 3 wt % aluminium and no more than 97 wt % silicon.

In third aspect, the present invention provides a particulate material consisting of a plurality of porous particles comprising an electroactive material, wherein the particulate material is obtainable by a process according to the second aspect of the invention. The process of the second aspect of the invention may be used to obtain the particulate material as defined with reference to the first aspect of the invention. Thus, the particulate material of the third aspect of the invention is preferably as defined with regard to the first aspect of the invention, and may have any of the features described as preferred or optional with regard to the first aspect of the invention.

In a fourth aspect of the invention, there is provided a composition comprising a particulate material according to the first and/or third aspect of the invention and at least one other component. In particular, the particulate material of the first and/or third aspects of the invention may be used as a component of an electrode composition. Thus, there is provided an electrode composition comprising a particulate material according to the first and/or third aspect of the invention and at least one other component selected from: (i) a binder; (ii) a conductive additive; and (iii) an additional particulate electroactive material. The particulate material used to prepare the electrode composition of the fourth aspect of the invention may have any of the features described as preferred or optional with regard to the first aspect of the invention and/or may be prepared by a process including any of the features described as preferred or optional with regard to the second aspect of the invention.

The particulate electroactive material of the invention preferably constitutes at least 60% by weight of, more preferably at least 70 wt %, and most preferably at least 80 wt %, for example at least 85 wt %, at least 90 wt %, or at least 95 wt % of the total weight of the electrode composition.

The electrode composition may optionally be a hybrid electrode composition which comprises a particulate material according to the first and/or third aspect of the invention and at least one additional particulate electroactive material. Examples of additional particulate electroactive materials include graphite, hard carbon, silicon, germanium, gallium, aluminium and lead. The at least one additional particulate electroactive material is preferably selected from graphite and hard carbon, and most preferably the at least one additional particulate electroactive material is graphite.

The electrode composition may optionally comprise a binder. A binder functions to adhere the electrode composition to a current collector and to maintain the integrity of the electrode composition. Examples of binders which may be used in accordance with the present invention include polyvinylidene fluoride (PVDF), polyacrylic acid (PAA) and alkali metal salts thereof, modified polyacrylic acid (mPAA) and alkali metal salts thereof, carboxymethylcellulose (CMC), modified carboxymethylcellulose (mCMC), sodium carboxymethylcellulose (Na-CMC), polyvinylalcohol (PVA), alginates and alkali metal salts thereof, styrene-butadiene rubber (SBR), and polyimide. The electrode composition may comprise a mixture of binders. Preferably, the binder comprises polymers selected from polyacrylic acid (PAA) and alkali metal salts thereof, and modified polyacrylic acid (mPAA) and alkali metal salts thereof, SBR and CMC.

The binder may suitably be present in an amount of from 0.5 to 20 wt %, preferably 1 to 15 wt % and most preferably 2 to 10 wt %, based on the total weight of the electrode composition.

The binder may optionally be present in combination with one or more additives that modify the properties of the binder, such as cross-linking accelerators, coupling agents and/or adhesive accelerators.

The electrode composition may optionally comprise one or more conductive additives. Preferred conductive additives are non-electroactive materials which are included so as to improve electrical conductivity between the electroactive components of the electrode composition and between the electroactive components of the electrode composition and a current collector. The conductive additives may suitably be selected from carbon black, carbon fibres, carbon nanotubes, acetylene black, ketjen black, metal fibres, metal powders and conductive metal oxides. Preferred conductive additives include carbon black and carbon nanotubes.

The one or more conductive additives may suitably be present in a total amount of from 0.5 to 20 wt %, preferably 1 to 15 wt % and most preferably 2 to 10 wt %, based on the total weight of the electrode composition.

In a fifth aspect, the invention provides an electrode comprising a particulate material as defined with reference to the first and/or third aspect of the invention in electrical contact with a current collector. The particulate material used to prepare the electrode composition of the fifth aspect of the invention may have any of the features described as preferred or optional with regard to the first aspect of the invention and/or may be prepared by a process including any of the features described as preferred or optional with regard to the second aspect of the invention.

As used herein, the term current collector refers to any conductive substrate which is capable of carrying a current to and from the electroactive particles in the electrode composition. Examples of materials that can be used as the current collector include copper, aluminium, stainless steel, nickel, titanium and sintered carbon. Copper is a preferred material. The current collector is typically in the form of a foil or mesh having a thickness of between 3 to 500 μm. The particulate material of the invention may be applied to one or both surfaces of the current collector to a thickness which is preferably in the range of from 10 μm to 1 mm, for example from 20 to 500 μm, or from 50 to 200 μm.

Preferably, the electrode comprises an electrode composition as defined with reference to the fourth aspect of the invention in electrical contact with a current collector. The electrode composition may have any of the features described as preferred or optional with regard to the fourth aspect of the invention. In particular, it is preferred that the electrode composition comprises one or more additional particulate electroactive materials as defined above.

The electrode of the fifth aspect of the invention may suitably be fabricated by combining the particulate material of the invention (optionally in the form of the electrode composition of the invention) with a solvent and optionally one or more viscosity modifying additives to form a slurry.

The slurry is then cast onto the surface of a current collector and the solvent is removed, thereby forming an electrode layer on the surface of the current collector. Further steps, such as heat treatment to cure any binders and/or calendaring of the electrode layer may be carried out as appropriate. The electrode layer suitably has a thickness in the range of from 20 μm to 2 mm, preferably 20 μm to 1 mm, preferably 20 μm to 500 μm, preferably 20 μm to 200 μm, preferably 20 μm to 100 μm, preferably 20 μm to 50 μm.

Alternatively, the slurry may be formed into a freestanding film or mat comprising the particulate material of the invention, for instance by casting the slurry onto a suitable casting template, removing the solvent and then removing the casting template. The resulting film or mat is in the form of a cohesive, freestanding mass which may then be bonded to a current collector by known methods.

The electrode of the fifth aspect of the invention may be used as the anode of a metal-ion battery. Thus, in a sixth aspect, the present invention provides a rechargeable metal-ion battery comprising an anode, the anode comprising an electrode as described above, a cathode comprising a cathode active material capable of releasing and reabsorbing metal ions; and an electrolyte between the anode and the cathode.

The metal ions are preferably selected from lithium, sodium, potassium, calcium or magnesium. More preferably the rechargeable metal-ion battery of the invention is a lithium-ion battery, and the cathode active material is capable of releasing and lithium ions.

The cathode active material is preferably a metal oxide-based composite. Examples of suitable cathode active materials include LiCoO₂, LiCO_{0.99}Al_{0.01}O₂, LiNiO₂, LiMnO₂, LiCO_{0.5}Ni_{0.5}O₂, LiCo_{0.7}Ni_{0.3}O₂, LiCO_{0.8}Ni_{0.2}O₂, LiCO_{0.82}Ni_{0.18}O₂, LiCO_{0.8}Ni_{0.15}Al_{0.05}O₂, LiNi_{0.4}CO_{0.3}Mn_{0.3}O₂ and LiNi_{0.33}CO_{0.33}Mn_{0.34}O₂. The cathode current collector is generally of a thickness of between 3 to 500 μm. Examples of materials that can be used as the cathode current collector include aluminium, stainless steel, nickel, titanium and sintered carbon.

The electrolyte is suitably a non-aqueous electrolyte containing a metal salt, e.g. a lithium salt, and may include, without limitation, non-aqueous electrolytic solutions, solid electrolytes and inorganic solid electrolytes. Examples of non-aqueous electrolyte solutions that can be used include non-protic organic solvents such as propylene carbonate, ethylene carbonate, butylene carbonates, dimethyl carbonate, diethyl carbonate, gamma butyrolactone, 1,2-dimethoxyethane, 2-methyltetrahydrofuran, dimethylsulfoxide, 1,3-dioxolane, formamide, dimethylformamide, acetonitrile, nitromethane, methylformate, methyl acetate, phosphoric acid triesters, trimethoxymethane, sulfolane, methyl sulfolane and 1,3-dimethyl-2-imidazolidinone.

Examples of organic solid electrolytes include polyethylene derivatives polyethyleneoxide derivatives, polypropylene oxide derivatives, phosphoric acid ester polymers, polyester sulfide, polyvinylalcohols, polyvinylidine fluoride and polymers containing ionic dissociation groups.

Examples of inorganic solid electrolytes include nitrides, halides and sulfides of lithium salts such as Li₅NI₂, Li₃N, LiI, LiSiO₄, Li₂SiS₃, Li₄SiO₄, LiOH and Li₃PO₄.

The lithium salt is suitably soluble in the chosen solvent or mixture of solvents. Examples of suitable lithium salts include LiCl, LiBr, LiI, LiClO₄, LiBF₄, LiBC₄O₈, LiPF₆, LiCF₃SO₃, LiAsF₆, LiSbF₆, LiAlCl₄, CH₃SO₃Li and CF₃SO₃Li.

Where the electrolyte is a non-aqueous organic solution, the battery is preferably provided with a separator interposed between the anode and the cathode. The separator is typically formed of an insulating material having high ion permeability and high mechanical strength. The separator typically has a pore diameter of between 0.01 and 100 μm and a thickness of between 5 and 300 μm. Examples of suitable electrode separators include a micro-porous polyethylene film.

The separator may be replaced by a polymer electrolyte material and in such cases the polymer electrolyte material is present within both the composite anode layer and the composite cathode layer. The polymer electrolyte material can be a solid polymer electrolyte or a gel-type polymer electrolyte.

In a seventh aspect, the invention provides the use of a particulate material as defined with reference to the first and/or third aspect of the invention as an anode active material. Preferably, the particulate material is in the form of an electrode composition as defined with reference to the fifth aspect of the invention, and most preferably the electrode composition comprises one or more additional particulate electroactive materials as defined above.

The invention will now be described by way of examples and the accompanying figures, in which:

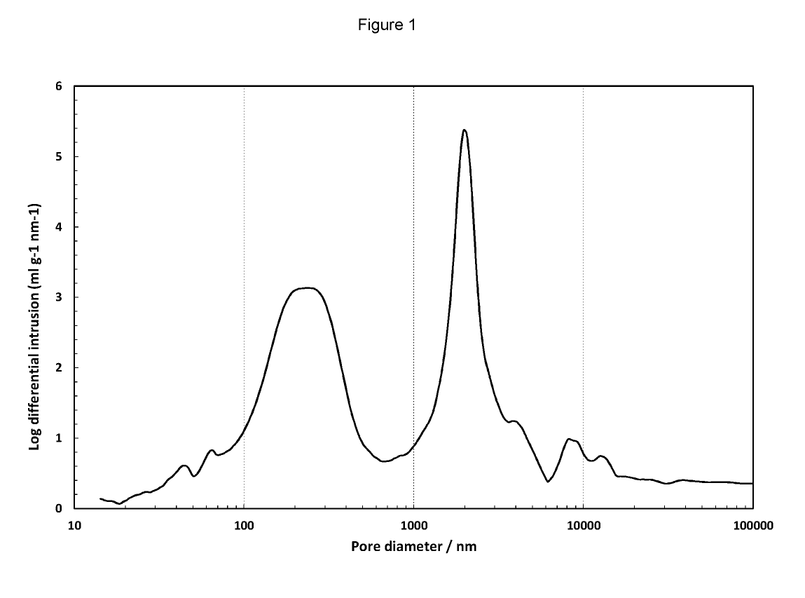

FIG. 1 shows the pore diameter distribution of the particulate material obtained according to Example 1, as determined by mercury porosimetry.

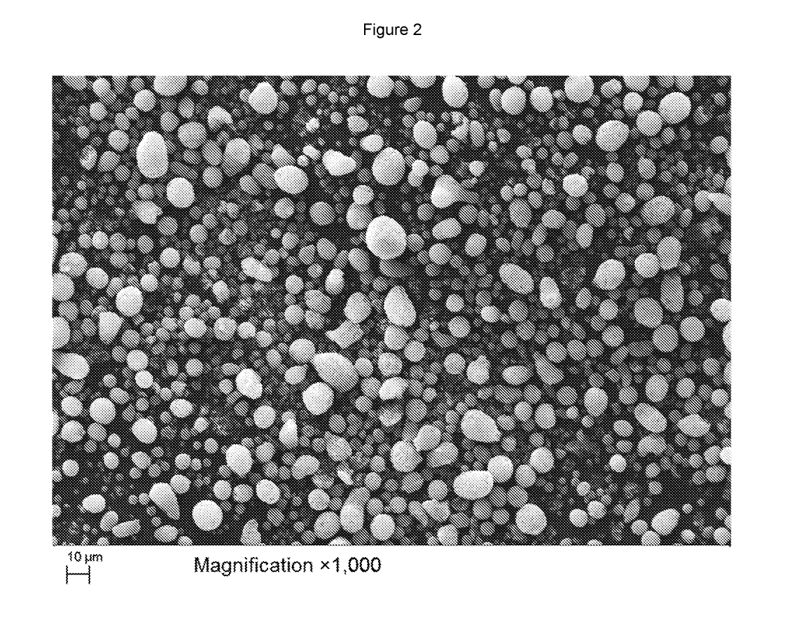

FIG. 2 is a scanning electron micrograph image of a plurality of particles obtained according to Example 1.

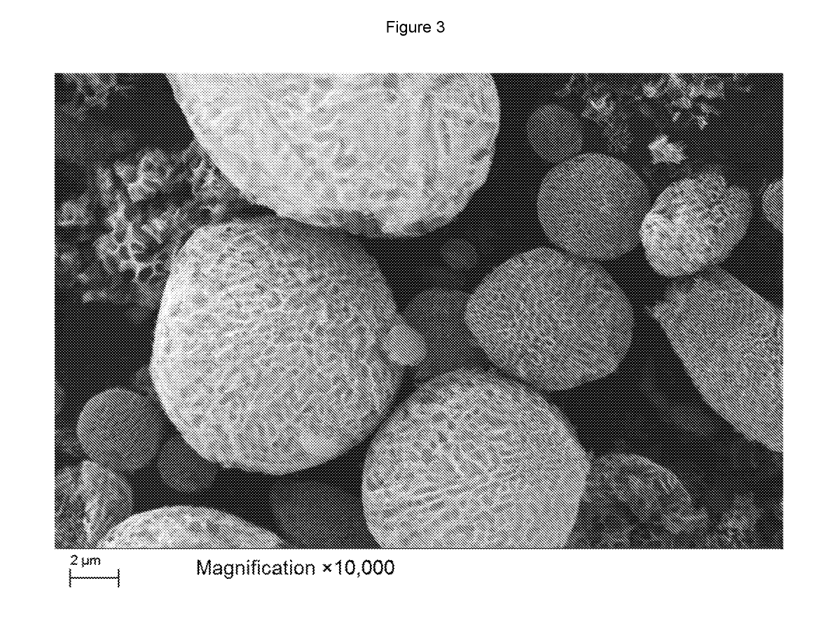

FIG. 3 is a close up view of the particles of FIG. 2 showing the surface morphology.

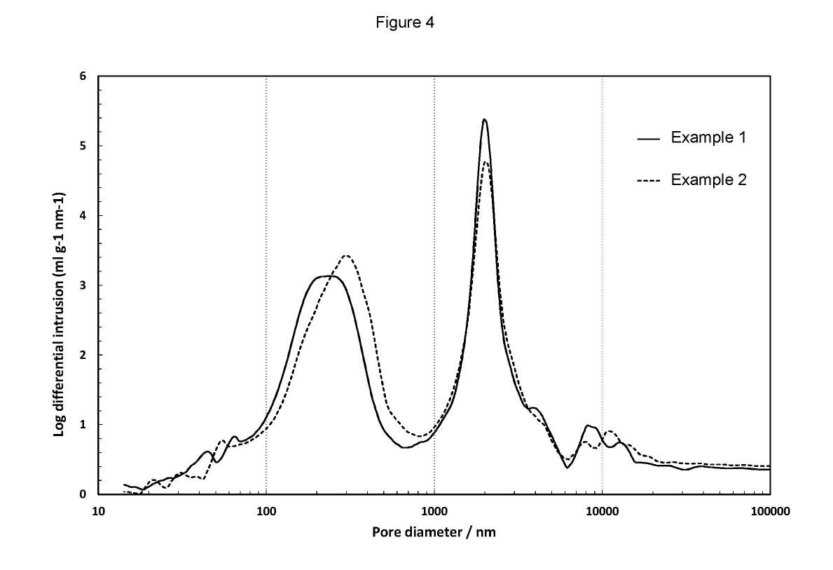

FIG. 4 shows the overlaid pore diameter distributions of the particulate materials obtained according to Examples 1 and 2, as determined by mercury porosimetry.

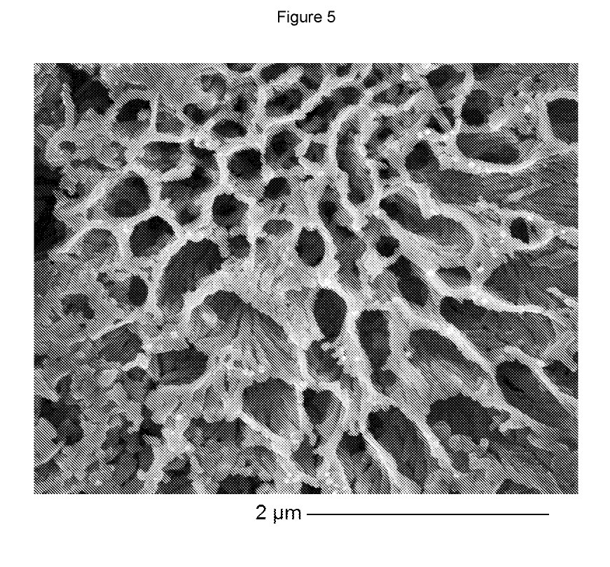

FIG. 5 shows a cross-sectional scanning electron micrograph image of a particle obtained according to Example 2. The image shows pores with diameters of 200 nm to 300 nm.

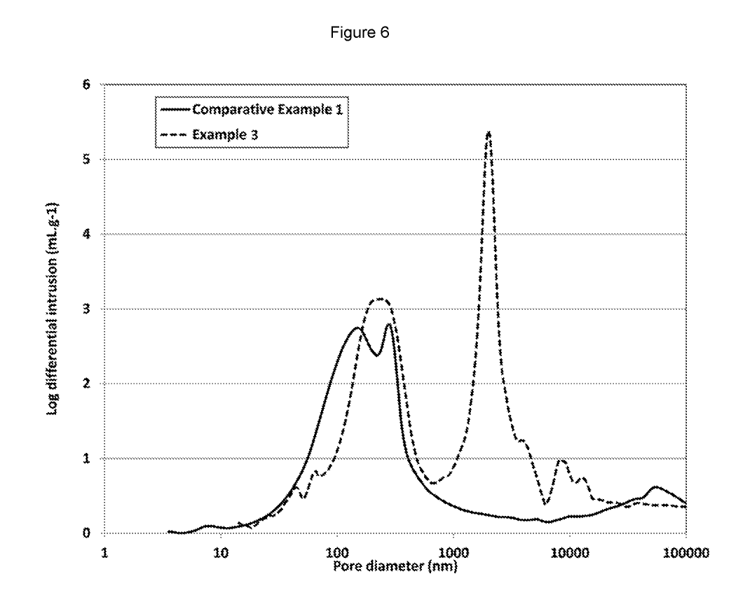

FIG. 6 shows the pore diameter distribution of the particulate material obtained according to Example 3 and Comparative Example 1, as determined by mercury porosimetry

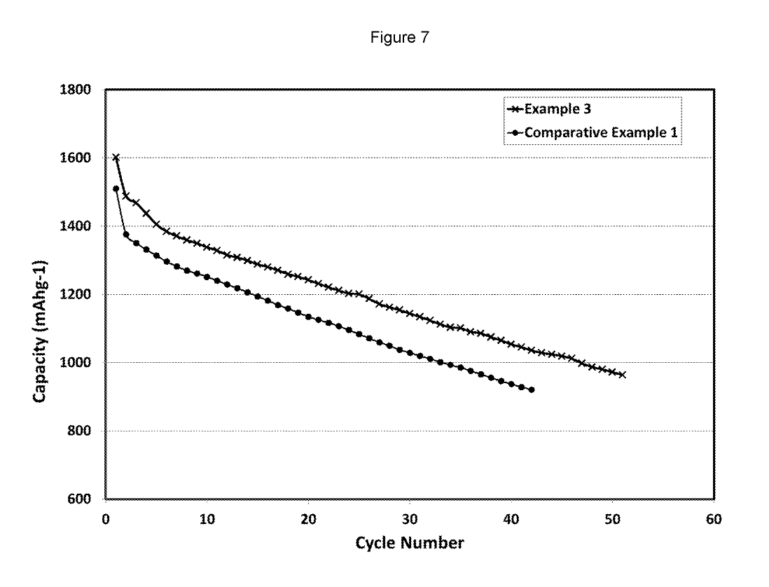

FIG. 7 shows the gravimetric discharge capacity of full cells comprising a negative electrode comprising 70 wt % of Example 3 or Comparative Example 1 porous particles as a function of charge-discharge cycle.

### EXAMPLES

General Procedure for Leaching of Alloy Particles

Alloy particles (5 g) are slurried in deionised water (50 mL) and the slurry is added to a 1 L stirred reactor containing aqueous HCl (450 mL, 6 M). The reaction mixture is stirred at ambient temperature for 20 minutes. The reaction mixture is then poured into deionised water (1 L) and the solid product is isolated by Buchner filtration. The product is dried in an oven at 75° C. before analysis.

### Example 1

Particles of an aluminium-silicon alloy (12 wt % silicon) were leached according to the general procedure set out above. The alloy particles were obtained by gas atomisation of the molten alloy with a cooling rate of ca. 10⁵ K/s followed by classification of the gas atomised product to obtain alloy particles having a D₅₀ particle diameter of 5.2 μm, a D₁₀ particle diameter of 10.2 μm, and a D₉₀ particle diameter of 18.4 μm. The alloy particles contained iron and other metallic impurities in a total amount of less than 0.5 wt %.

The porous particles obtained after the leaching process had a D₅₀ particle diameter of 10.6 μm, a D₁₀ particle diameter of 4.9 μm, and a D₉₀ particle diameter of 20.3 μm. The particle size distribution span was 1.45. The residual aluminium content of the porous particles was 5.5 wt % based on the total weight of the porous particles.

The pore diameter distribution of the porous particles is shown in FIG. 1. An intra-particle peak is observed at a pore diameter of 236 nm and an inter-particle peak is observed at a pore diameter of 1974 nm. The position of the inter-particle peak is in good agreement with the inter-particle pore diameter of 1640 nm calculated from close-packed spheres of diameter 10.6 μm. The BET value of the leached product was 117 m²/g.

### Example 2

Particles of an aluminium-silicon alloy (11.7 wt % silicon) were leached according to the general procedure set out above. The alloy particles were obtained by gas atomisation of the molten alloy with a cooling rate of ca. 10⁵ K/s followed by classification of the gas atomised product to obtain alloy particles having a D₅₀ particle diameter of 13.2 μm, a D₁₀ particle diameter of 5.9 μm, and a D₉₀ particle diameter of 26.5 μm. The alloy particles contained iron and other metallic impurities in a total amount of less than 0.5 wt %.

The porous particles obtained after the leaching process had a D₅₀ particle diameter of 14.6 μm, a D₁₀ particle diameter of 5.7 μm, and a D₉₀ particle diameter of 31.4 μm. The particle size distribution span was 1.76. The residual aluminium content of the porous particles was 5.1 wt % based on the total weight of the porous particles.

The pore diameter distribution of the porous particles is shown in FIG. 4. An intra-particle peak is observed at a pore diameter of 300 nm and an inter-particle peak is observed at a pore diameter of 2057 nm. The position of the inter-particle peak is in good agreement with the inter-particle pore diameter of 2259 nm calculated from close-packed spheres of diameter 14.6 μm. The BET value of the leached product was 61 m²/g.

### Example 3

A powder of particles of an aluminium-silicon alloy (12.3 wt % silicon) having a D₁₀ particle diameter of 5.2 μm, a D₅₀ particle diameter of 10.2 μm, and a D₉₀ particle diameter of 18.4 μm was obtained by gas atomisation of the molten alloy with a particle cooling rate of ca. 10⁵ K/s. The alloy particles contained iron and other metallic impurities in a total amount of less than 0.5 wt %.

The alloy particles were leached according to the general procedure set out above. The porous particles obtained after the leaching process had a D₅₀ particle diameter of 10.7 μm, a D₁₀ particle diameter of 4.7 μm, and a D₉₀ particle diameter of 20 μm. The residual aluminium content of the porous particles was 4.5 wt % based on the total weight of the porous particles and the BET value was 106 m²/g.

### Comparative Example 1

Comparative porous particles were made by selecting and leaching smaller particles of an aluminium-silicon alloy (12.6 wt % silicon) according to the general procedure set out above. The alloy particles were obtained by gas atomisation of the molten alloy with a cooling rate of >10⁵ K/s followed by classification of the gas atomised product to obtain alloy particles having a D₅₀ particle diameter of 3.7 μm, a D₁₀ particle diameter of 1.8 μm, and a D₉₀ particle diameter of 7.3 μm, and a BET value of 1.5 m²/g. The alloy particles contained 0.15 wt % iron and other metallic and carbon impurities in a total amount of less than 0.05 wt %.

The comparative porous particles obtained after the leaching process had a D₅₀ particle diameter of 4.4 μm, a D₁₀ particle diameter of 1.7 μm, and a D₉₀ particle diameter of 7.1 μm. The elemental composition of the porous particles was 5.3 wt % Al, 0.7 wt % Fe, the remainder being silicon and native oxide. The BET value of the leached porous particles was 125 m²/g.

The pore diameter distribution of the porous particles of Example 3 and Comparative Example 1 is shown in FIG. 6. The peak in the intra-particle pore-size distribution of Example 3 is 236 nm, larger than that of Comparative Example 1 at 153 nm. In each case, the second peak at a higher pore size represents that of the inter-particle pore size distribution which is dependent on particle size.

### Example 4—Process to Form Electrode and Coin Cell Comprising the Porous Particles

Coin test cells were made with negative electrodes comprising either Example 3 or Comparative Example 1 porous particles as follows. A dispersion of conductive carbons (a mixture of carbon black, carbon fibres and carbon nanotubes) in water was mixed in a Thinky® mixer with the porous particles. A CMC/SBR binder solution (CMC:SBR ratio of 1:1) was then mixed in to prepare a slurry with a solids content of 40 wt % and a weight ratio of the porous particles:CMC/SBR:conductive carbon of 70:16:14. The slurry was then coated onto a 10 μm thick copper substrate (current collector) and dried at 50° C. for 10 minutes, followed by further drying at 120-180° C. for 12 hours to thereby form an electrode comprising an active layer on the copper substrate. Coin half cells were then made using circular electrodes of 0.8 cm radius cut from this electrode with a porous polyethylene separator, a lithium foil as the counter electrode and an electrolyte comprising 1M LiPF₆ in a 7:3 solution of EC/FEC (ethylene carbonate/fluoroethylene carbonate) containing 3 wt % vinylene carbonate.

These half cells were used to measure the initial charge and discharge capacity and first cycle efficiency of the active layer and the expansion in thickness of the active layer at the end of the second charge (in the lithiated state). For expansion measurements, at the end of the second charge, the electrode was removed from the cell in a glove box and washed with DMC (dimethyl carbonate) to remove any SEI layer formed on the active materials. The electrode thickness was measured before cell assembly and then after disassembly and washing. The thickness of the active layer was derived by subtracting the known thickness of the copper substrate. The volumetric energy density of the electrode, in mAh/cm³, was calculated from the initial charge capacity and the volume of the active layer in the lithiated state after the second charge.

### Example 5—Production and Test of Full Cells

Coin cells were made as for half cells except that the lithium counter electrode was replaced by an LCO (lithium cobalt oxide) cathode with a coat weight of 3.7 g/cm³. Cell cycling tests were performed as follows. A constant current is applied at a rate of C/25 (wherein “C” represents the specific capacity of the anode in mAh, “25” refers to 25 hours), to lithiate the anode, with a cut off voltage of 4.2 V. When the cut off is reached, a constant voltage of 4.2 V is applied until a cut off current of C/100 is reached. The cell is then rested for 1 hour in the lithiated state. The anode is then delithiated at a constant current of C/25 with a cut off voltage of 3V. The cell is then rested for 1 hour. After this initial cycle, a constant current of C/2 is applied to lithiate the anode with a 4.2 V cut off voltage, followed by a 4.2 V constant voltage with a cut off current of 0/40. The anode is then delithiated at a constant current of C/2 with a 3.0 V cut off. The cell is then rested for 5 minutes. This is then repeated for the desired number of cycles. The results are shown in Table 1.

TABLE 1

| Porous | | | | Electrode | Volumetric |
|---|---|---|---|---|---|
| particles used | Gravimetric Energy | Gravimetric Energy | | thickness | Energy |
| in negative | Density (mAh/g) | Density (mAh/g) | First Cycle | Expansion | Density |
| electrode | 1st charge | 1st discharge | Efficiency | (%) | (mAh/cm³) |
| Example 3 | 3103 | 2482 | 80% | 67% | 488 |
| Comparative | 3049 | 2176 | 71% | 62% | 347 |
| Example 1 | | | | | |

The values in Table 1 are averages from three test cells of each type. It has been found that whilst the first cycle charge capacity of both cells are similar, both the first cycle efficiency and volumetric energy density of the negative electrode comprising Example 3 porous particles is much higher than for the electrode comprising Comparative Example 1 porous particles.

FIG. 7 plots the gravimetric discharge capacity of full cells comprising a negative electrode comprising 70 wt % of Example 3 or Comparative Example 1 porous particles as a function of charge-discharge cycle. It has been found that the cell comprising Example 3 porous particles maintains a higher energy density than the comparative cell over many cycles.

1. A particulate material consisting of a plurality of porous particles comprising an electroactive material selected from silicon, germanium or a mixture thereof, wherein the porous particles have a D₅₀ particle diameter in the range of greater than 5 to 25 μm, an intra-particle porosity in the range of from 30 to 90%, and a pore diameter distribution having at least one peak in the range of from 50 to less than 400 nm as determined by mercury porosimetry.

2. A particulate material according to claim 1, wherein the particulate material comprises at least 60 wt %, preferably at least 70 wt %, more preferably at least 75 wt %, more preferably at least 80 wt %, and most preferably at least 85 wt % of the electroactive material.

3. A particulate material according to claim 1 or claim 2, wherein the electroactive material comprises at least 90 wt %, preferably at least 95 wt %, more preferably at least 98 wt %, more preferably at least 99 wt % silicon.

4. A particulate material according to any one of the preceding claims, wherein the particulate material comprises a minor amount of one or more additional elements selected from aluminium, antimony, copper, magnesium, zinc, manganese, chromium, cobalt, molybdenum, nickel, beryllium, zirconium, iron, sodium, strontium, phosphorus, tin, ruthenium, gold, silver, and oxides thereof.

5. A particulate material according to claim 4, wherein the particulate material comprises a minor amount of aluminium, nickel, silver or copper, preferably aluminium.

6. A particulate material according to claim 5, wherein the particulate material comprises at least 60 wt % silicon and up to 40 wt % aluminium, preferably at least 70 wt % silicon and up to 30 wt % aluminium, more preferably at least 75 wt % silicon and up to 25 wt % aluminium, more preferably at least 80 wt % silicon and up to 20 wt % aluminium, more preferably at least 85 wt % silicon and up to 15 wt % aluminium, more preferably at least 90 wt % silicon and up to 10 wt % aluminium, and most preferably at least 95 wt % silicon and up to 5 wt % aluminium.

7. A particulate material according to claim 5 or claim 6, wherein the particulate material comprises at least 0.01 wt % aluminium, at least 0.1 wt % aluminium, at least 0.5 wt % aluminium, at least 1 wt % aluminium, or at least 2 wt % aluminium, or at least 3 wt % aluminium.

8. A particulate material according to any one of the preceding claims, wherein the porous particles have a D₅₀ particle diameter of at least 6 μm, at least 7 μm, at least 8 μm, or at least 10 μm.

9. A particulate material according to any one of the preceding claims, wherein the porous particles have a D₅₀ particle diameter of no more than 20 μm, no more than 18 μm, no more than 15 μm, or no more than 12 μm.

10. A particulate material according to any one of the preceding claims, wherein the porous particles have a D₁₀ particle diameter of at least 1 μm, preferably at least 2 μm, more preferably at least 3 μm.

11. A particulate material according to any one of the preceding claims, wherein the porous particles have a D₉₀ particle diameter of no more than 40 μm, preferably no more than 30 μm, more preferably no more than 25 μm, and most preferably no more than 20 μm.

12. A particulate material according to any one of the preceding claims, wherein the porous particles have a D₉₉ particle diameter of no more than 50 μm, more preferably no more than 40 μm, more preferably no more than 30 μm, and most preferably no more than 25 μm.

13. A particulate material according to any one of the preceding claims, wherein the porous particles have a particle size distribution span of 5 or less, preferably 4 or less, more preferably 3 or less, more preferably 2 or less, and most preferably 1.5 or less.

14. A particulate material according to any one of the preceding claims, wherein the porous particles have an intra-particle porosity of at least 40%, preferably at least 50%, and more preferably at least 60%

15. A particulate material according to any one of the preceding claims, wherein the porous particles have an intra-particle porosity of no more than 87%, preferably no more than 86%, more preferably no more than 85%, more preferably no more than 80%, and most preferably no more than 75%.

16. A particulate material according to any one of the preceding claims, wherein the particulate material has a pore diameter distribution having at least one peak at a pore size less than 380 nm, preferably less than 360 nm, and more preferably less than 350 nm, as determined by mercury porosimetry.

17. A particulate material according to any one of the preceding claims, wherein the particulate material has a pore diameter distribution having at least one peak at a pore size of more than 60 nm, preferably more than 80 nm, and more preferably more than 100 nm, as determined by mercury porosimetry.

18. A particulate material according to any one of the preceding claims, wherein the porous particles are spheroidal particles having an average sphericity Sₐᵥ of at least 0.70, preferably at least 0.85, more preferably at least 0.90, preferably at least 0.92, more preferably at least 0.93, more preferably at least 0.94, more preferably at least 0.95, more preferably at least 0.96, more preferably at least 0.97, more preferably at least 0.98 and most preferably at least 0.99.

19. A particulate material according to any one of the preceding claims, wherein the porous particles have an average aspect ratio of less than 3:1, preferably no more than 2.5:1, more preferably no more than 2:1, preferably no more than 1.8:1, more preferably no more than 1.6:1, more preferably no more than 1.4:1 and most preferably no more than 1.2:1.

20. A particulate material according to any one of the preceding claims, having a BET surface area of less than 300 m²/g, preferably less than 200 m²/g, more preferably less than 150 m²/g, more preferably less than 120 m²/g.

21. A particulate material according to any one of the preceding claims, having a BET surface area of at least 10 m²/g, at least 15 m²/g at least 20 m²/g, or at least 50 m²/g.

22. A particulate material according to any one of the preceding claims, wherein the porous particles comprise a network of interconnected irregular elongate structural elements, preferably wherein the porous particles comprise structural elements having an aspect ratio of at least 2:1 and more preferably at least 5:1.

23. A particulate material according to claim 22, wherein the porous particles comprise structural elements having a smallest dimension less than 300 nm, preferably less than 200 nm, more preferably less than 150 nm, and a largest dimension at least twice, and preferably at least five times the smallest dimension.

24. A particulate material according to claim 22 or claim 23, wherein the porous particles comprise structural elements having a smallest dimension of at least 10 nm, preferably at least 20 nm, preferably at least 30 nm.

25. A process for the preparation of a particulate material consisting of a plurality of porous particles comprising an electroactive material, the process comprising the steps of:
(a) providing a plurality of alloy particles, wherein the alloy particles are obtained by cooling a molten alloy comprising: (i) from 11 to 45 wt % of an electroactive material component selected from silicon, germanium and mixtures thereof; and (ii) a matrix metal component, wherein said alloy particles have a D₅₀ particle diameter in the range of greater than 5 to 25 μm, and wherein said alloy particles comprise discrete electroactive material containing structures dispersed in the matrix metal component;
(b) leaching the alloy particles from step (a) to remove at least a portion of the matrix metal component and to at least partially expose the electroactive material containing structures;
wherein the porous particles comprise no more than 40% by weight of the matrix metal component.

26. A process according to claim 25, wherein the alloy particles have a D₅₀ particle diameter of at least 6 μm, preferably at least 7 μm, more preferably at least 8 μm, and most preferably at least 10 μm.

27. A process according to claim 25 or claim 26, wherein the alloy particles have a D₅₀ particle diameter of no more than 20 μm, preferably no more than 18 μm, more preferably no more than 15 μm, and most preferably no more than 12 μm.

28. A process according to any one of claims 25 to 27, wherein the alloy particles have a D₁₀ particle diameter of at least 1 μm, preferably at least 2 μm, and most preferably at least 3 μm.

29. A process according to any one of claims 25 to 28, wherein the alloy particles have a D₉₀ particle diameter of no more than 40 μm, preferably no more than 30 μm, more preferably no more than 25 μm, and most preferably no more than 20 μm.

30. A process according to any one of claims 25 to 29, wherein the alloy particles have a D₉₉ particle diameter of no more than 40 μm, more preferably no more than 30 μm, and most preferably no more than 25 μm.

31. A process according to any one of claims 25 to 30, wherein the alloy particles have a particle size distribution span of 5 or less, preferably 4 or less, more preferably 3 or less, more preferably 2 or less, and most preferably 1.5 or less.

32. A process according to any one of claims 25 to 31, wherein the alloy particles have an average sphericity Sₐᵥ of at least 0.70, preferably at least 0.85, more preferably at least 0.90, preferably at least 0.92, more preferably at least 0.93, more preferably at least 0.94, more preferably at least 0.95, more preferably at least 0.96, more preferably at least 0.97, more preferably at least 0.98, and most preferably at least 0.99.

33. A process according to any one of claims 25 to 32, wherein the alloy particles have an average aspect ratio of less than 3:1, preferably no more than 2.5:1, more preferably no more than 2:1, preferably no more than 1.8:1, more preferably no more than 1.6:1, more preferably no more than 1.4:1 and most preferably no more than 1.2:1.

34. A process according to any one of claims 25 to 33, wherein the electroactive material component of the alloy particles comprises at least 90 wt %, preferably at least 95 wt %, more preferably at least 98 wt %, more preferably at least 99 wt % silicon.

35. A process according to any one of claims 25 to 34, wherein the alloy particles comprise at least 11.2 wt %, more preferably at least 11.5 wt %, more preferably at least 11.8 wt %, more preferably at least 12 wt %, and most preferably at least 12.2 wt % of the electroactive material component.

36. A process according to any one of claims 25 to 35, wherein the alloy particles comprise less than 40 wt %, preferably less than 35 wt %, preferably less than 30 wt %, more preferably less than 25 wt %, more preferably less than 20 wt %, and most preferably less than 18 wt % of the electroactive material component.

37. A process according to any one of claims 25 to 36, wherein the matrix metal component of the alloy particles is selected from aluminium, antimony, copper, magnesium zinc, manganese, chromium, cobalt, molybdenum, nickel, beryllium, zirconium, iron, tin, ruthenium, silver, gold and combinations thereof.

38. A process according to claim 37, wherein the matrix metal component of the alloy particles comprises at least 50 wt %, preferably at least 60 wt %, more preferably at least 70 wt %, more preferably at least 80 wt %, more preferably at least 90 wt % and most preferably at least 95 wt % of one or more of aluminium, nickel, silver or copper, preferably of aluminium.

39. A process according to claim 38, wherein the electroactive material component of the alloy particles comprises at least 90 wt %, more preferably at least 95 wt %, preferably at least 98 wt %, more preferably at least 99 wt % silicon and the matrix metal component of the alloy particles comprises at least 90 wt %, more preferably at least 95 wt % aluminium.

40. A process according to any one of claims 25 to 39, wherein the particulate material comprises no more than 30 wt %, more preferably no more than 25 wt %, more preferably no more than 20 wt %, more preferably no more than 15 wt %, more preferably no more than 10 wt %, and most preferably no more than 5 wt % of the matrix metal component, relative to the total weight of the particulate material.

41. A process according to any one of claims 25 to 40, wherein the particulate material comprises at least 0.01 wt %, at least 0.1 wt %, at least 0.5 wt %, at least 1 wt %, at least 2 wt %, or at least 3 wt % of the matrix metal component, relative to the total weight of the particulate material.

42. A process according to any one of claims 25 to 41 wherein the alloy particles in step (a) are obtained by cooling a molten alloy from the liquid state to the solid state at a cooling rate of at least 5×10⁴ K/s, or at least 1×10⁵ K/s.

43. A particulate material consisting of a plurality of porous particles comprising an electroactive material, wherein the particulate material is obtainable by a process as defined in any one of claims 25 to 442.

44. A particulate material according to claim 43, wherein the particulate material is as defined in any one of claims 1 to 24.

45. A composition comprising a particulate material as defined in any one of claims 1 to 24, 43 and 44, and at least one other component.

46. A composition according to claim 45, which is an electrode composition comprising a particulate material as defined in any one of claims 1 to 24, 43 and 44, and at least one other component selected from: (i) a binder; (ii) a conductive additive; and (iii) an additional particulate electroactive material.

47. An electrode composition according to claim 46, wherein the particulate material constitutes at least 60% by weight, more preferably at least 70 wt %, and most preferably at least 80 wt %, for example at least 85 wt %, at least 90 wt %, or at least 95 wt % of the total weight of the electrode composition.

48. An electrode composition according to claim 46 or claim 47, comprising at least one additional particulate electroactive material.

49. An electrode composition according to claim 48, wherein the at least one additional particulate electroactive material is selected from graphite, hard carbon, silicon, germanium, gallium, aluminium and lead.

50. An electrode composition according to any one of claims 46 to 49, comprising a binder, preferably in an amount of from 0.5 to 20 wt %, more preferably 1 to 15 wt % and most preferably 2 to 10 wt %, based on the total weight of the electrode composition.

51. An electrode composition according to any one of claims 46 to 50, comprising one or more conductive additives, preferably in a total amount of from 0.5 to 20 wt %, more preferably 1 to 15 wt % and most preferably 2 to 10 wt %, based on the total weight of the electrode composition.

52. An electrode comprising a particulate material as defined in any one of claims 1 to 24, 43 and 44 in electrical contact with a current collector.

53. An electrode according to claim 52, wherein the particulate material is in the form of an electrode composition as defined in any one of claims 46 to 51.

54. A rechargeable metal-ion battery comprising: (i) an anode, wherein the anode comprises an electrode as described in claim 52 or claim 53; (ii) a cathode comprising a cathode active material capable of releasing and reabsorbing metal ions; and (iii) an electrolyte between the anode and the cathode.

55. Use of a particulate material as defined in any one of claims 1 to 24, 43 and 44 as an anode active material.

56. Use according to claim 55, wherein the particulate material is in the form of an electrode composition as defined in any one of claims 46 to 51.
